(19) United States
(12) Patent Application Publication
(10) Pub. No.: US 2008/0137024 A1
(43) Pub. Date: Jun. 12, 2008

(54) LIQUID CRYSTAL DISPLAY DEVICE, MANUFACTURING METHOD OF LIQUID CRYSTAL DISPLAY DEVICE AND MOTHER SUBSTRATE OF LIQUID CRYSTAL DISPLAY DEVICE

(76) Inventors: Takahiro Nagami, Mobara (JP); Hiroaki Endo, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/951,391

(22) Filed: Dec. 6, 2007

(30) Foreign Application Priority Data
Dec. 8, 2006 (JP) 2006-331433

(51) Int. Cl. G02F 1/1339; H01J 9/26

(52) U.S. Cl. 349/154; 445/25

(57) ABSTRACT

A liquid crystal sealing inlet is formed by a edge sealing material, and a sealing-inlet columnar spacer is formed so as to prevent the edge sealing material from running over to adjacent liquid crystal cells when bonding a TFT substrate and a color filter substrate together.

The present application claims priority from Japanese applications JP2006-331433 filed on Dec. 8, 2006, the content of which is hereby incorporated by reference into this application.

### BACKGROUND OF THE INVENTION

The invention relates to a liquid crystal display device, particularly, relates to a configuration in which many liquid crystal cells can be obtained from a mother substrate.

In the liquid crystal display device, in a general way, many liquid-crystal cell substrates are formed on a large grass substrate (mother substrate) according to the request on manufacturing costs, and manufacturing processes are performed in the unit of the mother substrate, then, after the completion, liquid crystal cells are cut off.

A liquid crystal cell is formed by a TFT substrate in which pixel electrodes, thin-film transistors (TFTs) and the like are formed and an opposite substrate in which color filters and the like are formed. Many TFT substrates are formed at a time by being allocated in a large TFT-mother substrate and subjected to manufacturing processes by each TFT-mother substrate. Similarly, many opposite substrates are formed at a time by being allocated in a large opposite-mother substrate and subjected to manufacturing processes by each opposite-mother substrate.

The TFT-mother substrate and the opposite mother substrate are manufactured separately, and both substrates are combined with each other, when they are completed. At this time, edge sealing portions are formed at respective cell portions by edge sealing material made of organic resin by each TFT substrate or each opposite substrate, and the TFT-mother substrate and the opposite-mother substrate are bonded by respective edge sealing material. After the TFT-mother substrate and the opposite-mother substrate are bonded together, respective liquid crystal cells are cut off.

Before the TFT-mother substrate and the opposite mother substrate are bonded together, the edge sealing portions are formed by edge sealing material at each TFT substrate or each opposite substrate, and the edge sealing portions are formed around each substrate. When the TFT-mother substrate and the opposite-mother substrate are bonded together, both the substrates are press bonded. At this time, edge sealing material spreads sideways. When the edge sealing material spreads sideways, there is a fear that the edge sealing material runs over adjacent liquid crystal cells. If such runover occurs, there causes a problem that respective liquid crystal cells can not be cut off in good condition when they are cut off after the TFT-mother substrate and the opposite-mother substrate are bonded together. Accordingly, in related arts, the TFT substrates on the TFT-mother substrate are arranged with a fixed space, considering the runover of edge sealing material. Therefore, the number of TFT substrates which can be produced from the TFT-mother substrate is limited.

As one of conventional techniques for solving the above problems, for example, “Patent Document 1” can be cited. In the following “Patent Document 1”, a technique in which, when the edge sealing material is coated on respective substrates by using a dispenser, sealing shape of the edge sealing material is devised to prevent interference is disclosed. As another conventional technique, the following “Patent Document 2” can be cited. In the following “Patent Document 2”, considering the interference by the edge sealing material occurs in the vicinity of a liquid crystal sealing inlet when cutting off respective substrates, a technique is disclosed, in which the liquid crystal sealing inlet is formed after the mother substrate is cut into respective liquid crystal cells.

[Patent Document 1] JP-A-10-293310

[Patent Document 2] JP-A-8-201825

### SUMMARY OF THE INVENTION

In “Patent Document 1” described above, the technique in which edge sealing material is coated accurately by computer control is disclosed, however, there remains the problem that the distance between adjacent liquid crystal cells is small in the vicinity of the liquid crystal sealing inlet in which the interference of edge sealing material is particularly controversial, and the edge sealing material protrudes to cause interference with adjacent cells. Therefore, in order to avoid the problem that the edge sealing material runs over adjacent liquid crystal cells, there is also a problem that the adjacent liquid crystal cells should be arranged at a distance. Thus, the number of the liquid crystal cells that can be obtained from the mother substrate is decreased. In the second embodiment of “Patent Document 1”, to provide dot-like edge sealing materials on a start portion and an end portion of application by a dispenser is disclosed. This dot-like edge sealing material also has the same problem since the edge sealing material spreads in essence when the TFT-mother substrate and the opposite-mother substrate are bonded together. In “Patent Document 2”, since introduction means for injecting a liquid crystal is provided after separating each liquid crystal cell from the mother substrate, this leads to increase of a manufacturing cost.

In the present invention, a stopper is formed to prevent the edge sealing material from flowing to other liquid crystal cells particularly on the portion where a liquid crystal sealing inlet in which the interference of edge sealing material is easily generated. Thereby, even if the liquid crystal cells are arranged in adjacent each other in the mother substrate, it is possible to prevent the inconvenience when each liquid crystal cell is cut off from the mother substrate. Specific means is as follows.

(1) A liquid crystal display device having a first substrate, a second substrate, a liquid crystal sandwiched between the first substrate and the second substrate, and a edge sealing material bonding the first substrate and the second substrate together and having a liquid crystal sealing inlet on a first side; wherein, on the first side on which the liquid crystal sealing inlet is formed, the position of an end of the first substrate and the position of an end of the second substrate coincide with each other, and the liquid crystal display device has a columnar member that is located at the position to contact with the front end of the edge sealing material which forms the inlet portion of the liquid crystal sealing inlet, and is made of a material having a different component composition from that of the edge sealing material.

### (2) The liquid crystal display device according to (1), wherein the columnar member serves as a spacer for holding an interval between the first substrate and the second substrate.

(3) The liquid crystal display device according to (1) or (2), wherein the first substrate has a terminal to be connected to a flexible wiring substrate on a second side that is opposed to the first side, and on the second side, the end of the second substrate sets back from the end of the first substrate.

### (4) The liquid crystal display device according to (3), wherein the columnar member is formed on the second substrate.

### (5) The liquid crystal display device according to any of (1) to (4), wherein the liquid crystal sealing inlet increases the width thereof toward the outside of the liquid crystal display device.

(6) The liquid crystal display device according to any of (1) to (5), wherein the columnar member is formed by the same material as that of the spacer for setting an interval between the first substrate and the second substrate, which is formed on the part where the liquid crystal exists.

### (7) The liquid crystal display device according to any of (1) to (7), wherein the liquid crystal sealing inlet is sealed by a end sealing material, and the end sealing material contacts the edge sealing material.

(8) A manufacturing method of a liquid crystal display device sandwiching a liquid crystal between a first substrate and a second substrate that are bonded with each other via a edge sealing material; wherein a spacer for defining an interval between the first substrate and the second substrate is formed in a display area of the second substrate and a columnar member is formed on the end of the second substrate at the same time; the edge sealing material is formed on the outside of the display area of the second substrate so that a liquid crystal sealing inlet is provided in the vicinity of the portion where the columnar member is formed; and when bonding the first substrate and the second substrate together via the edge sealing material, the edge sealing material is allowed to contact the columnar member.

### (9) The manufacturing method of the liquid crystal display device according to (8), wherein the front end of the edge sealing material configuring the inlet portion of the liquid crystal sealing inlet is allowed to contact the columnar member.

### (10) The manufacturing method of the liquid crystal display device according to (8) or (9), wherein the first substrate has a thin film transistor, and the second substrate has a color filter.

(11) The manufacturing method of the liquid crystal display device according to any one of (8) to (10), wherein a plurality of first substrates is formed on the first mother substrate and a plurality of second substrates is formed on the second mother substrate, and the first mother substrate is bonded to the second mother substrate so that the first substrate corresponds to the second substrate, and then, each pair of the first substrate and the second substrate is separated, respectively.
(12) The manufacturing method of the liquid crystal display device according to (11), wherein the plurality of the first substrates is continuously arranged on the first mother substrate without a gap so that the portions to be separated of the first substrates being adjacent with each other via a side where the liquid crystal sealing inlet is arranged coincide with each other.
(13) A mother substrate of a liquid crystal display device having a first mother substrate on which a plurality of first substrates is arranged and a second mother substrate on which a plurality of second substrates is arranged are boned with each other via a edge sealing material; wherein the edge sealing material is formed so as to have a sealing inlet on the end of the mother substrate of the liquid crystal display device, the second substrate is mounted in the display area, and the mother substrate has a spacer for defining an interval between the first substrate and the second substrate and a columnar member that is located on the position to contact the edge sealing material configuring the inlet of the sealing inlet and formed of the same material as that of the spacer.

### (14) The mother substrate of the liquid crystal display device according to (13), wherein the mother substrate is polished so as to make the thickness of the substrate thinner.

According to the present invention, it is possible to prevent the edge sealing material from running over from the liquid crystal cells by means of the above-described means. As a result, it is possible to increase the number of the liquid crystal cells that can be obtained from the mother substrate. Effects of each of the above-described means are as follows:

According to the means (1), since the member made of a different material from that of the edge sealing material is formed in the liquid crystal sealing inlet in advance, it is possible to prevent the edge sealing material from running over to the adjacent liquid crystal cells in the vicinity of the sealing inlet. Accordingly, since there is no need to form a space for runover of the edge sealing material among the adjacent liquid crystal cells, the number of the liquid crystal cells that can be obtained from each mother substrate can be increased.

According to the means (2), since the columnar member to be formed in the sealing inlet has a role as a spacer, it is possible to hold the intervals of the liquid crystal cells evenly. In addition, the present invention has a large advantage such that the columnar member can be formed by the same process as that of the spacer in the display area.

According to means (3) and (4), when cutting off the liquid crystal cells from the mother substrate, even if the columnar member formed in the sealing inlet is cut off at the same time as the liquid crystal cells, the portion to be cut off is separated from the opposite substrate. As a result, a final product is not affected.

According to means (5), since the liquid crystal sealing inlet is formed so as to increase the width thereof toward the outside, it is possible to improve a reliability of sealing by sealing the sealing inlet by the end sealing material.

According to means (6), since the columnar member formed in the sealing inlet is formed by the same material and the same process as those of the spacer for setting an interval between the TFT substrate formed in the display area and the opposite substrate, it is advantageous in perspective of cost.

According to means (7), since the end sealing material for sealing the sealing inlet contacts the edge sealing material, it is possible to improve a reliability of a end sealing portion.

According to means (8), (9), and (10), since the columnar member is formed in the vicinity of the sealing inlet in advance when applying the edge sealing material so as to have the sealing inlet on the second substrate and the edge sealing material is prevented from running over to the adjacent liquid crystal cells by allowing the edge sealing material to contact the columnar member when superimposing the second substrate on the first substrate, it is possible to improve an a degree of accuracy of the edge sealing portion.

According to means (11) and (12), since the edge sealing material can be prevented from running over from the liquid crystal cells to the adjacent liquid crystal cells, the liquid crystal cells can be continuously formed in the mother substrate without having an interference area. Therefore, the number of the liquid crystal cells that can be obtained from each mother substrate can be increased.

According to means (13) and (14), when polishing the first substrate or the second substrate in the state of the mother substrate, wasteful area can be reduced in the entire mother substrate. In other words, since it is possible to prevent the edge sealing material for sealing the entire mother substrate from running over to the outside in the sealing inlet, there is no need to secure a margin on the mother substrate for runover of the edge sealing material. In other words, it becomes unnecessary to waste the protruded portions.

### BRIEF DESCRIPTION OF THE DRAWINGS

FIGS. 1A and 1B are outline views showing a liquid crystal cell according to a first embodiment of the invention.

FIG. 2 is a cross-sectional view taken along A-A line in FIG. 1.

FIG. 3 is a partial enlarged view of an opposed substrate.

FIG. 4 is a cross-sectional view taken along A-A line of FIG. 3.

FIG. 5 is an enlarged view of a liquid crystal sealing inlet portion.

FIG. 6 is a partial cross-sectional view of the liquid crystal sealing inlet portion.

FIGS. 7A and 7B are a plan view and a side view of a sealing-inlet columnar spacer.

FIG. 8 is a mother substrate of a liquid crystal cell.

FIG. 9 is a plan view of a TFT mother substrate and the opposite mother substrate.

FIG. 10 is another plan view of the TFT mother substrate and the opposite mother substrate.

FIG. 11 is a plan view of the sealing inlet portion in a middle step.

FIGS. 12A and 12B are cross-sectional views showing change of the edge sealing material.

FIGS. 13A and 13B are plan views showing a liquid crystal cell mother substrate.

FIGS. 14A and 14B are plan views of a liquid crystal cell.

FIGS. 15A and 15B are plan views of a liquid crystal cell after sealing.

FIGS. 16A and 16B are plan views of the sealing inlet portion using another sealing-inlet columnar spacer.

FIGS. 17A and 17B are plan views of the sealing inlet portion using still another sealing-inlet columnar spacer.

FIG. 18 is a plan view of the mother substrate having the edge sealing portion formed thereon.

FIG. 19 is cross-sectional view taken along A-A line of FIG. 18.

### DESCRIPTION OF THE PREFERRED EMBODIMENT

According to an embodiment, the invention will be disclosed in detail.

### Embodiment 1

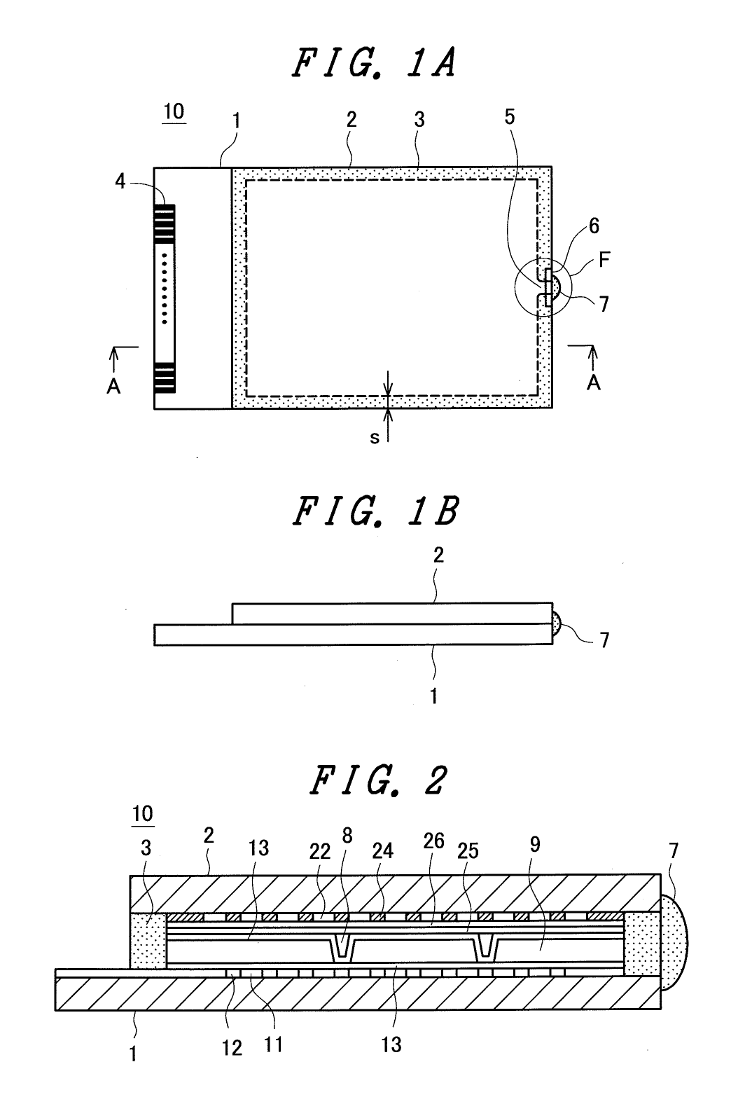

FIG. 1A and FIG. 1B are outline views showing a liquid crystal cell 10 according to a first embodiment of the invention, in which FIG. 1A is a plan view and FIG. 1B is a side view. In FIG. 1A, on a TFT substrate 1 in which pixel electrodes 11, TFT 12 and the like are formed in a matrix state, an opposite substrate 2 in which color filters and the like are formed is stacked and bonded through a edge sealing material 3. The color filters may be attached to the TFT substrate. The edge sealing material 3 is made of organic resin, and a width “s” of the edge sealing material 3 is approximately 0.7 mm. A gap of several μm is formed between the TFT substrate 1 and the opposite substrate 2, and a liquid crystal 9 is filled there between. On the TFT substrate 1, a terminal portion 4, not-shown driving IC chips and the like are attached, therefore, the TFT substrate is formed larger than the opposite substrate 2. A flexible wiring board is attached to the terminal portion 4 for supplying power, signals and the like from the outside.

A sealing inlet 5 for sealing the liquid crystal 9 is formed at the opposite side of the terminal portion 4 in FIG. 1A. Since it is necessary to form the edge sealing material 3 up to cutting surfaces of the liquid crystal cells 10, the problem of runover of the edge sealing material 3 tends to occur between adjacent liquid crystal cells 10 in the mother substrate at the portion of the sealing inlet 5. The present invention prevents the edge sealing material 3 from running over to the adjacent cell by forming a columnar spacer at this portion of the sealing inlet 5 as described later. The sealing inlet 5 is sealed by a end sealing material 7 made of organic resin.

FIG. 2 is a cross-sectional view taken along A-A line in FIG. 1A. The opposite substrate 2 is placed on the TFT substrate 1 through the edge sealing material 3. The liquid crystal 9 is filled in a space formed by the TFT substrate 1, the opposite substrate 2 and the edge sealing material 3. In FIG. 2, pixel electrodes 11 and TFTs 12 for controlling signals applied to the pixel electrodes 11 are formed in the TFT substrate 1. On the pixel electrodes 11 and the TFTs 12, an alignment layer 13 for aligning the liquid crystal 9 is formed. Scanning lines or signal lines to be data signal lines by being conductive with the TFTs 12 pierce through the edge sealing material and extend to the terminal portion 4.

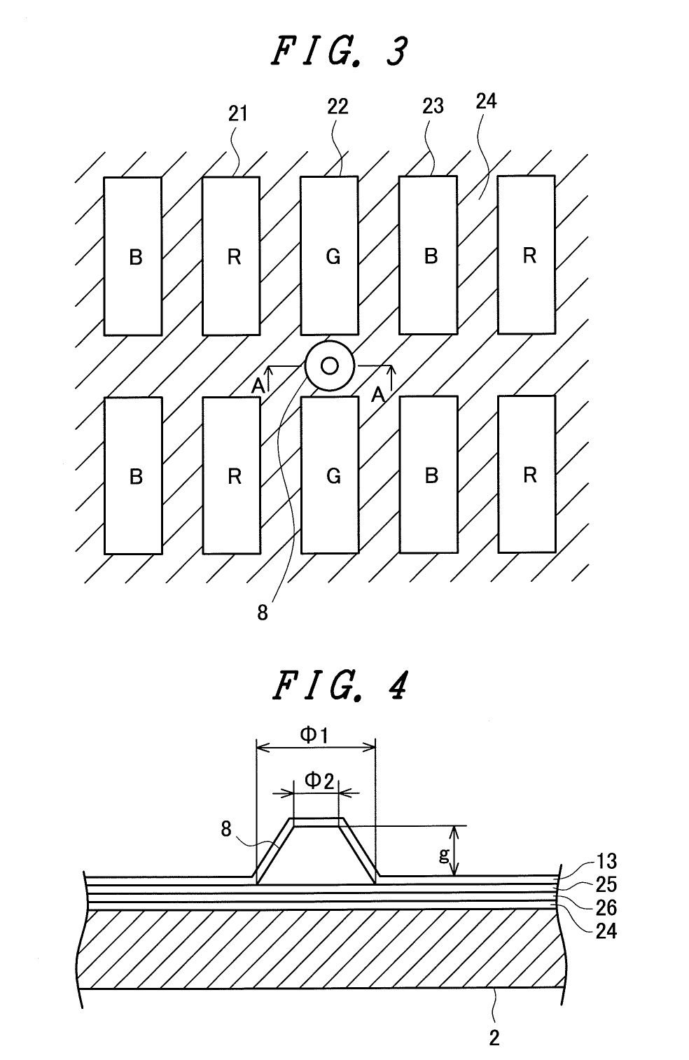

As shown in FIG. 3, in the opposite substrate 2, a red filter 21, a green filter 22 and a blue filter 23 are formed corresponding to the pixel electrodes 11 formed on the TFT substrate 1 to form color images. Since FIG. 2 is the A-A cross-section, the same color filter, namely, only the green filter can be seen. Respective filters are divided by a shielding film (BM 24). This is for improving contrast of images. A counter electrode 25 is formed covering the color filters and the BM 24. Liquid crystal molecules are moved by voltage between the counter electrode 25 and the pixel electrodes 11 to control transmitting light or reflected light so as to form images. The alignment layer 13 for covering the counter electrode 25 and aligning the liquid crystal 9 is formed. In an IPS liquid crystal display device which is driven by in-plane switching, the counter electrode 25 is formed on the side of the TFT substrate.

The edge sealing material 3 also has a function of setting a space between the TFT substrate 1 and the opposite substrate 2. Accordingly, a material in which spacers such as grass fibers for setting the space are dispersed in organic resin is used as the edge sealing material 3. As organic resin, for example, epoxy resin is used. The end sealing material 7 is for sealing the liquid crystal cell 10 after the liquid crystal 9 is filled in the liquid crystal cell 10.

Space is set by the edge sealing material 3 at an outer periphery of the liquid crystal cell 10, however, in a display area of the liquid crystal cell 10, the space between the TFT substrate 1 and the opposite substrate 2 is set by a display area spacer separately. In the embodiment, the space between the TFT substrate and the opposite substrate 2 is set by display-area columnar spacers 8. The columnar spacers 8 are formed in the opposite substrate 2 before the alignment layer 13 is formed. The columnar spacers 8 are formed in the following manner. An organic resin, generally formed of acrylic, is coated on the counter electrode 25 in the opposite substrate 2. The coating thickness is set to the thickness corresponding to the space between the TFT substrate 1 and the opposite substrate 2. After that, the organic resin is allowed to remain in a columnar shape at necessary portions by photolithography to form the display-area columnar spacers 8.

FIG. 3 is a plan view showing a place where the display-area columnar spacer 8 is set. FIG. 3 is an enlarged plan view of the opposite substrate 2 from the inside. In FIG. 3, the red filers 21, the green filters 22, the blue filters 23 and the BM 24 filled between them are shown, however, the counter electrode 25 and the alignment layer 13 are formed, covering respective filters and the like. The display-area columnar spacer 8 is formed on the counter electrode 25.

In FIG. 3, the display-area columnar spacer 8 is formed between the green filter 22 and the green filter 22. That is because a space for setting the display-area columnar spacer can be easily saved between a filter and a filter in a longitudinal direction. When the spacer is formed at this position, it is possible to prevent light transmittance of the liquid crystal cell 10 from being reduced. In addition, by forming the spacer at this position, it is possible to reduce the risk that the display-area columnar spacer 8 contacts the TFT 12 formed in the TFT substrate 1. Though the display-area columnar spacer 8 is formed between the green filter 22 and the green filter in FIG. 3, it may be formed between other filters as the matter of course. Additionally, it is not always necessary to set the display-area columnar spacer 8 at each filter, and the pitch in which the display-area columnar spacer 8 is set may be the pitch which is necessary for setting the space between the TFT substrate 1 and the opposite substrate 2 in the display area.

FIG. 4 is a cross-sectional view taken along A-A line of FIG. 3. The opposite substrate 2 is set downward in fact. However, as FIG. 3 is the view of the opposite substrate 2 seen from the bottom, the display-area columnar spacer 8 is shown in an upwards state. In FIG. 4, the BM 24 is formed on the opposite substrate 2, and an overcoat film 26 and the counter electrode 25 are formed thereon. The display-area columnar spacer 8 is formed on the counter electrode. A diameter φ1 of the display-area columnar spacer 8 on the counter electrode 25 is approximately 30 μm to 40 μm. Since the display-area columnar spacer 8 is formed by photolithography, a taper by etching is generated. According to the taper, an upper diameter φ2 is approximately 10 μm to 20 μm, therefore, a cross section of the display-area columnar spacer 8 is an almost trapezoid. A portion of the upper diameter of the display-area columnar spacer 8 contacts the TFT substrate 1.

FIG. 5 is a detailed plan view of an F portion representing the vicinity of the inlet in FIG. 1A. As shown in FIG. 5, a sealing-inlet columnar spacer 6 is disposed at a position touching tips of the edge sealing material 3 which forms an inlet portion of the sealing inlet 5. In FIG. 5, the sealing-inlet columnar spacer 6 is formed along a cutting line 101. Conversely, when the liquid crystal cell 10 is cut off from the mother substrate, the sealing-inlet columnar spacer 6 is also cut off. The edge sealing material spreads when the TFT mother substrate 100 is stacked on the opposite mother substrate 200, however, the spread to adjacent cells is prevented by the sealing-inlet columnar spacer 6. Sine the edge sealing material 3 is prevented from spreading to adjacent liquid crystal cells 10 in this manner, a distance “e” between an end of the edge sealing material 3 and an end of the glass cutting line 101 can be restricted to approximately 0.1 mm to 0.15 mm. This is equivalent to the distance between the end of the edge sealing material 3 and the end of the glass cutting line 101 at edges other than the edge in which the sealing inlet 5 is formed in the liquid crystal cell 10. Accordingly, in the configuration of the invention, more liquid crystal cells 10 can be taken from the mother substrate. After the sealing inlet 5 is formed, liquid crystal is filled, then, sealed with the end sealing material 7. The inside of the liquid crystal cell 10 is sealed by the end sealing material 7 touching the edge sealing material 3.

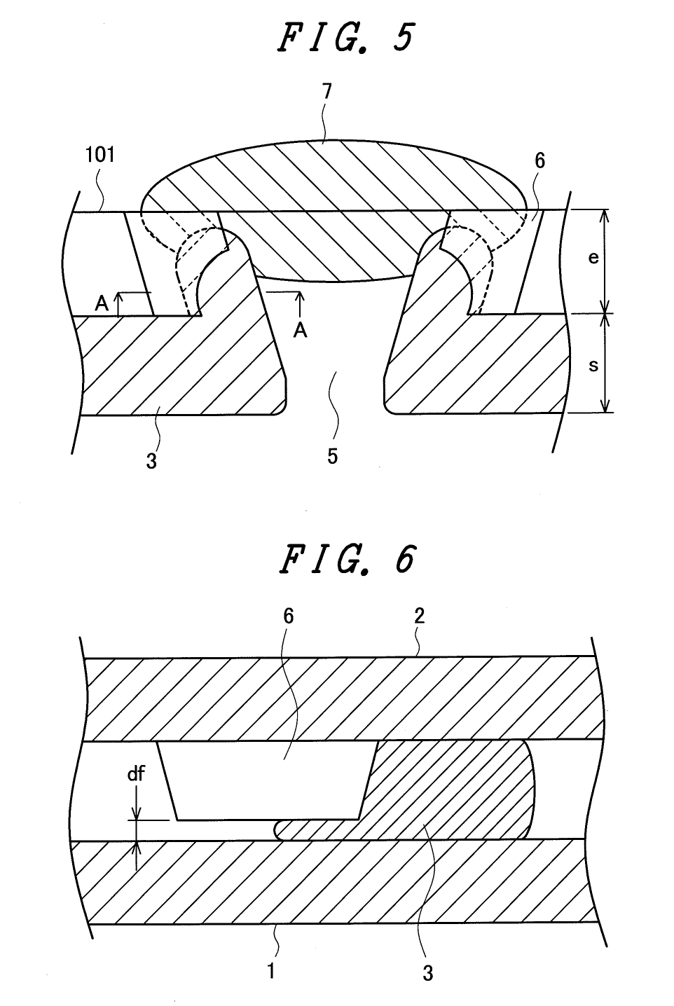

In FIG. 5, the reason why part of the edge sealing material 3 seems to enter under the sealing-inlet columnar spacer 6 is that the portion has a configuration shown in FIG. 6. FIG. 6 is a cross-sectional view taken along A-A line of FIG. 5. In FIG. 6, the sealing-inlet columnar spacer 6 is formed downward from the opposite substrate 2. Since the sealing-inlet columnar spacer 6 is set at the same height as the display-area columnar spacer 8, it is formed so as to touch the TFT substrate 1. However, a slight gap “df” is sometimes generated between the spacer 6 and the TFT substrate 1 because of manufacturing variation. The edge sealing material 3 penetrates into the slight gap by the capillary phenomenon, which allows the edge sealing material 3 to be also between the sealing-inlet columnar spacer 6 and the TFT substrate 1. However, the amount of the edge sealing material 3 entering by the capillary phenomenon is slight, therefore, it is still the fact that the sealing-inlet columnar spacer 6 serves as a stopper to prevent the edge sealing material 3 from spreading to adjacent cells.

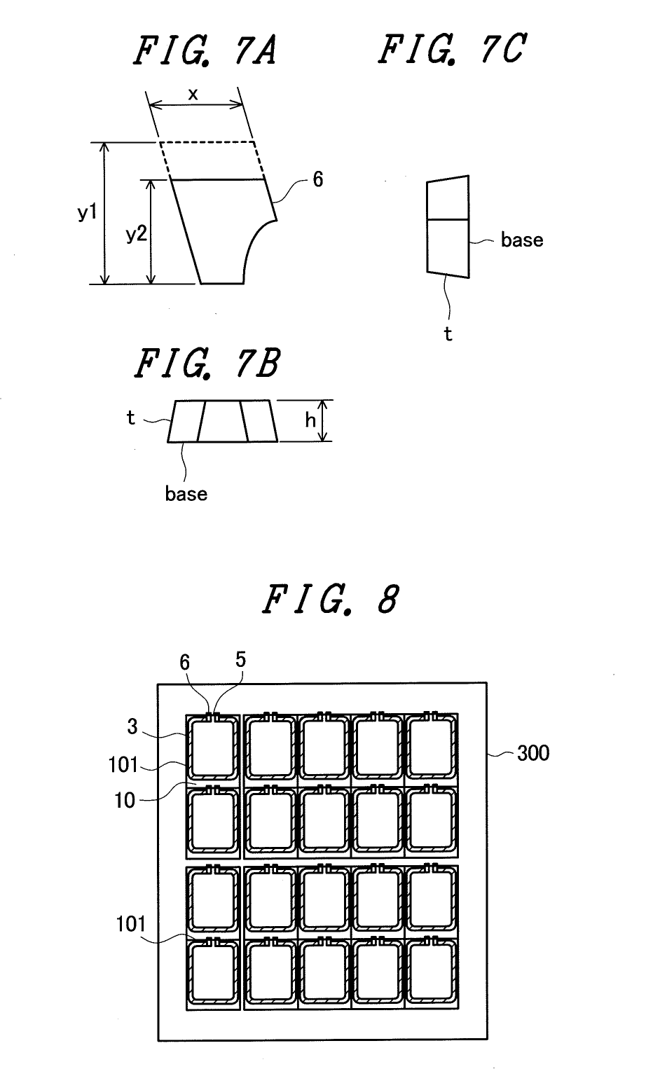

FIG. 7A to FIG. 7C are views showing the shape of the sealing-inlet columnar spacer 6. FIG. 7A is a plan view, FIG. 7B is a side view and FIG. 7C is another side view. The sealing-inlet columnar spacer 6 is not formed and set by itself but formed by developing or etching acrylic resin for forming the display-area columnar spacer 8, which has been coated on the opposite substrate 2. Therefore, a lower base of the sealing-inlet columnar spacer 6 shown in the drawing contacts the film formed on the opposite substrate 2. In addition, particular processes for forming the sealing-inlet columnar spacer 6 are not necessary and the sealing-inlet columnar spacer 6 is formed simultaneously by a photolithography process for forming the display-area columnar spacer 8, therefore, manufacturing costs do not increase. Material for the sealing-inlet columnar spacer 6 formed here has components different from the material for the edge sealing material 3. At any rate, when the edge sealing material 3 is coated, the sealing-inlet columnar spacer 6 already exists as a solid.

In FIG. 2, the transverse diameter “x” of the sealing-inlet columnar spacer 6 is, for example, 0.4 mm. A part of the sealing-inlet columnar spacer 6 is cut simultaneously when the liquid crystal cell 10 is cut off from the mother substrate. A portion shown by a dotted line is a cut-off portion. The longitudinal diameter “y1” of the sealing-inlet columnar spacer 6 before being cut off is, for example, 0.6 mm. The longitudinal diameter of the sealing-inlet columnar spacer 6 is 0.4 mm. A height “h” of the sealing-inlet columnar spacer 6 is equivalent to the space between the TFT substrate 1 and the opposite substrate 2. A taper “t” formed at a side surface in FIG. 7B is the taper formed by development or etching.

The liquid crystal cell 10 shown in FIG. 1A is cut off from the large mother substrate in which many liquid crystal cells 10 are formed as shown in FIG. 8. Many TFT substrates 1 of liquid crystal cells 10 are formed in the TFT-mother substrate 100. On the other hand, many opposite substrates 2 of liquid crystal cells 10 are formed in the opposite-mother substrate 200. FIG. 8 shows a state in which the TFT-mother substrate 100 and the opposite-mother substrate which were fabricated separately are stacked with each other through the edge sealing material 3 formed on respective liquid crystal cells 10. Respective liquid crystal cells 10 are cut off by cutting the mother substrate at cutting lines 101 formed on the mother substrate shown in FIG. 10. The edge sealing material 3 shown in FIG. 8 is formed under the opposite substrate 2, however, it is shown by solid lines for avoiding complication of the drawing.

The more the liquid crystal cells 10 can be taken from the mother substrate, the more advantageous manufacturing costs are. When the size of the mother substrate is the same, the smaller the intervals between liquid crystal cells 10 are, the more liquid crystal cells 10 can be taken. In related arts, spaces are necessary at intervals between respective liquid crystal cells 10 for preventing the edge sealing material 3 from running over to adjacent other liquid crystal cells 10 particularly at portions of the liquid crystal sealing inlets 5. In the present embodiment, as described above, the sealing-inlet columnar spacers 6 are provided at sealing-inlet portions to prevent the edge sealing material 3 from running over to adjacent other liquid crystal cells 10. Accordingly, extra spaces on the assumption that the edge sealing material 3 runs over adjacent substrates can be omitted, as a result, the number of the liquid crystal cells 10 in the mother substrate can be increased.

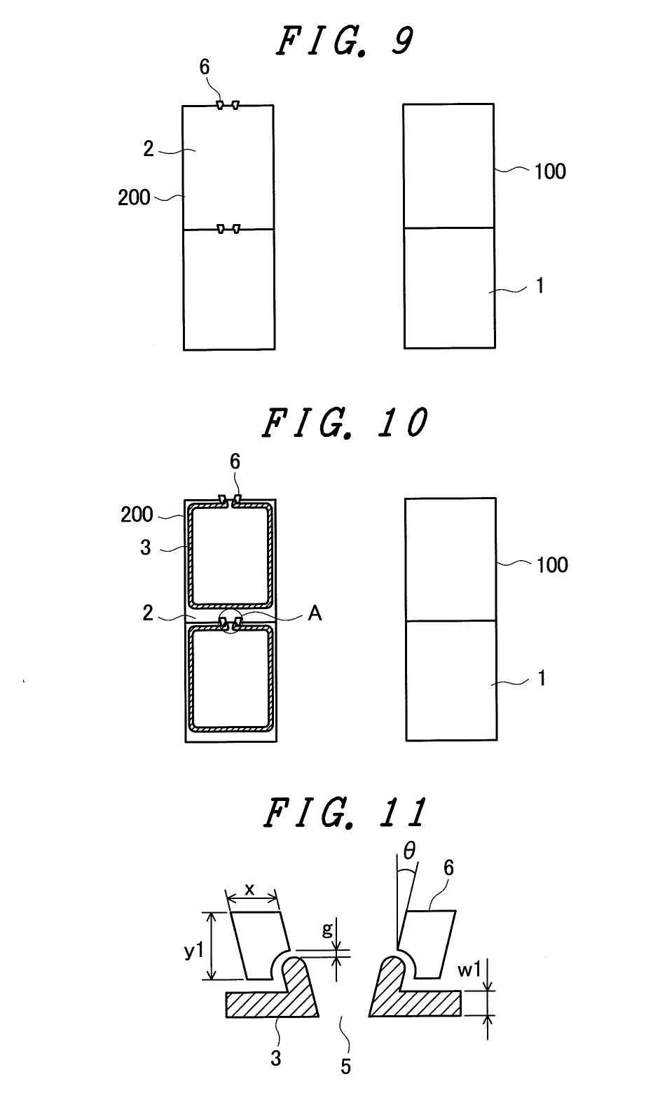

Processes for manufacturing the present liquid crystal cell 10 are shown in FIG. 9 to FIG. 15B. As shown in FIG. 8 in fact, many TFT substrates 1 are formed in the TFT-mother substrate 100 or many opposite substrates 2 are formed in the opposite mother substrate 200, however, for simplification, a case in which two TFT substrates 1 or two opposite substrates 2 are continuously set is explained in FIG. 9 to FIG. 15B.

FIG. 9 shows a state in which the TFT-mother substrate 100 and the opposite-mother substrate 200 are formed separately. Through not shown in FIG. 9, the TFT substrate 1 is in a state in which the pixel electrodes, the TFTs, the scanning lines, the data signal lines, the alignment layer and the like shown in FIG. 2 are already formed. In addition, though not shown, in the opposite substrate 2, the color filters, the BM, the counter electrode, the alignment layer, the display-area columnar spacers and the like are already formed. In FIG. 9, the sealing-inlet columnar spacer 6 is formed in the vicinity of the cutting line in the opposite mother substrate 200. The liquid-crystal sealing inlet is formed at the portion.

In FIG. 10, the edge sealing material 3 is set at respective liquid crystal cells 10 in the opposite-mother substrate 200. A position surrounded by the edge sealing material 3 is largely set back from the end of the substrate at one end of the opposite substrate 2. The portion being set back will be cut off from the liquid crystal cell 10 later. In FIG. 10, the coating of the edge sealing material 3 is performed by a dispenser or by printing. The TFT substrates 1 in FIG. 10 are the same as the TFT substrates 1 in FIG. 9. The TFT substrates 1 have been already completed at the time of FIG. 9.

FIG. 11 is an A-portion enlarged view of FIG. 10, which is the detailed view of the vicinity of the sealing inlet. In FIG. 11, the edge sealing material 3 is coated so that the sealing inlet 5 spreads outside in the sealing inlet portion. A width “w1” of the edge sealing material 3 is, for example, approximately 0.2 mm. The edge sealing material 3 is coated with a space “g” which is approximately 0.1 mm with respect to the sealing-inlet columnar spacer 6. This is on the ground that the edge sealing material 3 is pushed and widened when the TFT-mother substrate 100 and the opposite-mother substrate 200 are bonded together. The sealing-inlet columnar spacer 6 formed in advance before the edge sealing material is coated has the transverse diameter “x” of 0.4 mm and the longitudinal diameter “y1” of 0.6 mm as it is before being cut. The sealing-inlet columnar spacer 6 is set so that the inside of the sealing-inlet columnar spacer 6 has an angle θ with respect to the normal line of an edge of the opposite substrate 2. The θ in the present embodiment is 15 degrees. This angle is for allowing the liquid-crystal sealing inlet 5 to spread outside.

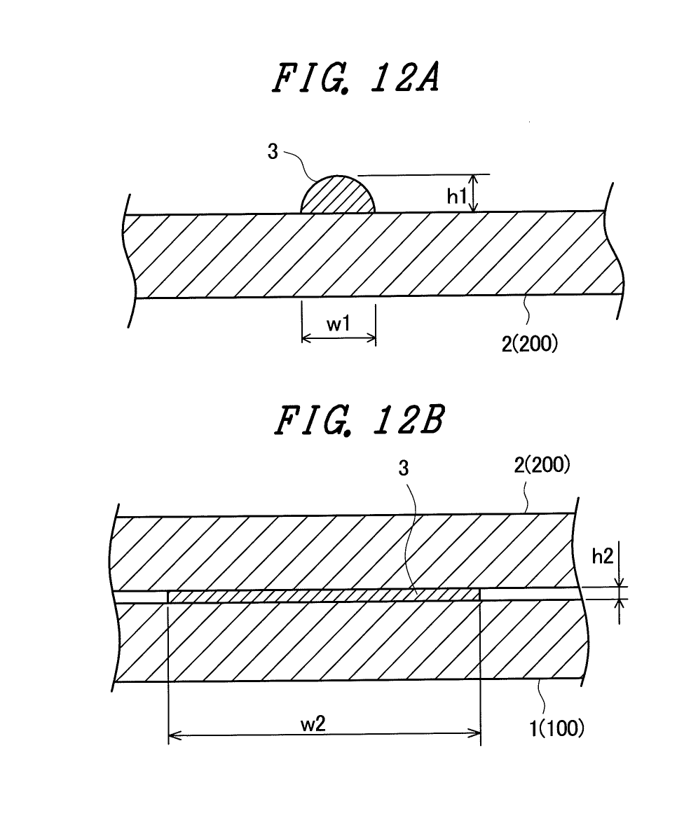

FIGS. 12A and 12B show change between the state that the edge sealing material 3 is applied on the opposite mother substrate 200 and the state that the opposite mother substrate 200 is superimposed on the TFT mother substrate 100. In FIG. 12A, the edge sealing material 3 is applied on the opposite mother substrate 200 by the dispenser with the width w1 of 0.2 mm and the height h1 from about 20 μm to about 30 μm. After that, when the opposite mother substrate 200 is bonded to the TFT mother substrate 100, the edge sealing material 3 crushes and spreads to be as shown in FIG. 12B. In FIG. 12B, the width w2 of the edge sealing material 3 spreads to be about 0.7 mm. The thickness h2 of the edge sealing material 3 is made smaller up to the interval between the TFT substrate 1 and the opposite substrate 2, and it is about several μm, for example, 3 μm to 6 μm.

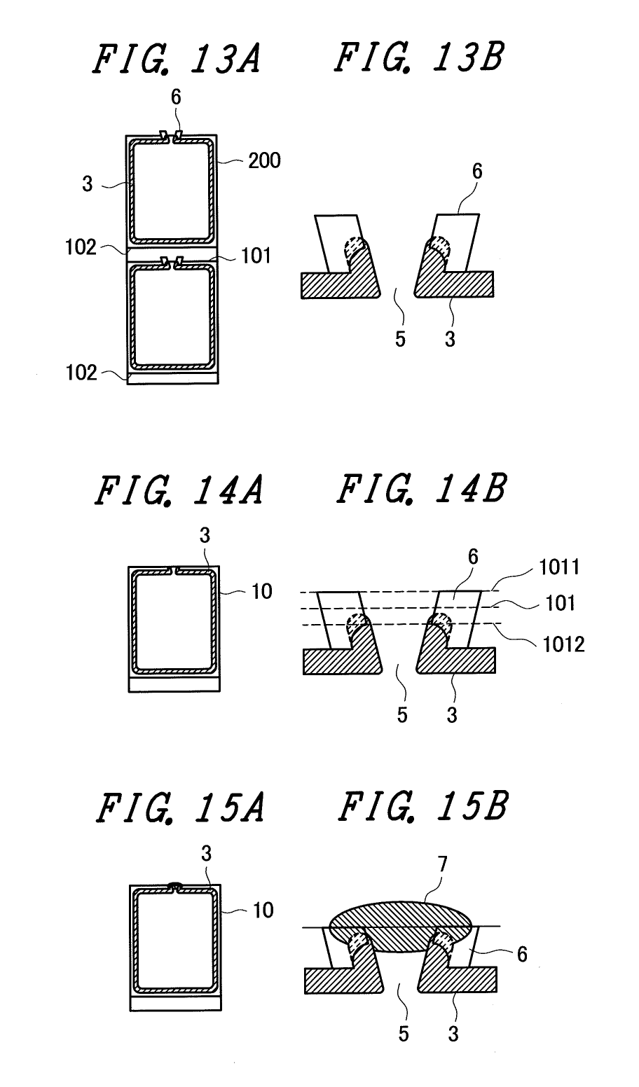

FIG. 13A shows the state that the TFT mother substrate 100 and the opposite mother substrate 200 are bonded together. FIG. 13A is a plan view seeing the bonded state from the side of the opposite mother substrate. Although the edge sealing material is formed on the lower side of the opposite mother substrate 200, it is represented by a solid line for making it clearly understandable.

FIG. 13B shows the state of the vicinity of the sealing inlet in this case. In FIG. 13B, the edge sealing material 3 crashes and spreads, but the sealing-inlet columnar spacer 6 serves as a stopper so as to prevent the edge sealing material 3 from spreading further from the sealing-inlet columnar spacer 6. Thereby, it is possible to prevent the edge sealing material 3 from entering the adjacent liquid crystal cells 10. The side of the edge sealing material of the sealing-inlet columnar spacer 6 is shaped with a part being notched in order to easily prevent the edge sealing material 3 from entering the adjacent liquid crystal cells 10.

The sealing-inlet columnar spacer 6 is shaped so as to spread outward for the sealing inlet 5. Thereby, even after the opposite mother substrate 200 is superimposed to the TFT mother substrate 100, the liquid crystal sealing inlet 5 can spread outward because a reliability of the end sealing portion can be increased in the case that the liquid crystal sealing inlet 5 can spread more as moving outward. A part of the edge sealing material 3 penetrates into the gap between the sealing-inlet columnar spacer 6 and the TFT substrate 1 by the capillary phenomenon as described with reference to FIG. 6.

In FIG. 13A, the liquid crystal cell cutting lines 101 and an opposite substrate cutting lines 102 are described. The liquid crystal cell cutting lines 101 is for cutting off the liquid crystal cells 10 from the mother substrate. In this state, the opposite substrate 2 and the TFT substrate 1 have the same size. After that, a part of the opposite substrate 2 outer than the edge sealing material 3 is cutoff at the opposite substrate cutting line 102.

FIG. 14A shows this state after the cut off. In FIG. 14A, by cutting off a part of the opposite substrate 2 at the opposite substrate cutting line 102, apart of the TFT substrate 1 is exposed. On this portion, the terminal portion 4 of the wiring, the flexible wiring substrate to be connected to the terminal portion, and the driving IC chips or the like are arranged. FIG. 14B shows the state of the cutting line 101 of the liquid crystal cell 10. A design value of the cutting line is a line represented by 101. However, the cutting line 101 is easily varied. In practice, the cutting line 101 is varied against the design value with about 0.2 mm. A line 1011 shows the case that the cutting line deviates outside. In this case, since the edge sealing material 3 does not remain among the adjacent liquid crystal cells 10, so that there is no problem. A line 1012 shows the case that the cutting line deviates inside. Also in this case, the amount of the edge sealing material 3 entering the cutting line is very small, so that there is no problem for separation of each cell after cutting. When the cell is cut off at 101, a part of the columnar spacer 6 remains in the adjacent liquid crystal cell; however, the columnar spacer 6 is formed on the opposite substrate 2 and a part of the columnar spacer 6 is removed when the cell is cut off at 102, so that the columnar spacer 6 does not remain in the final product. Accordingly, it is possible to continuously arrange the liquid crystal cells without a gap so that the separation portion at 101 of two panels adjacent with each other via the sealing inlet coincide with each other.

FIG. 15A and FIG. 15B show the state that the sealing inlet 5 is sealed by the edge sealing material after sealing the liquid crystal into the liquid crystal cell 10 that is formed in this way. An organic resin is used for the end sealing material. Since the sealing inlet 5 is configured so that its size becomes smaller inwardly, the edge sealing material 3 and the end sealing material 7 can be easily bonded, so that a reliability of the end sealing portion can be increased. Further, since the end sealing material 7 has a better adhesiveness with the edge sealing material 3 than the sealing-inlet columnar spacer 6, as shown in FIG. 15B, it is preferable that the end sealing material 7 contacts the edge sealing material 3.

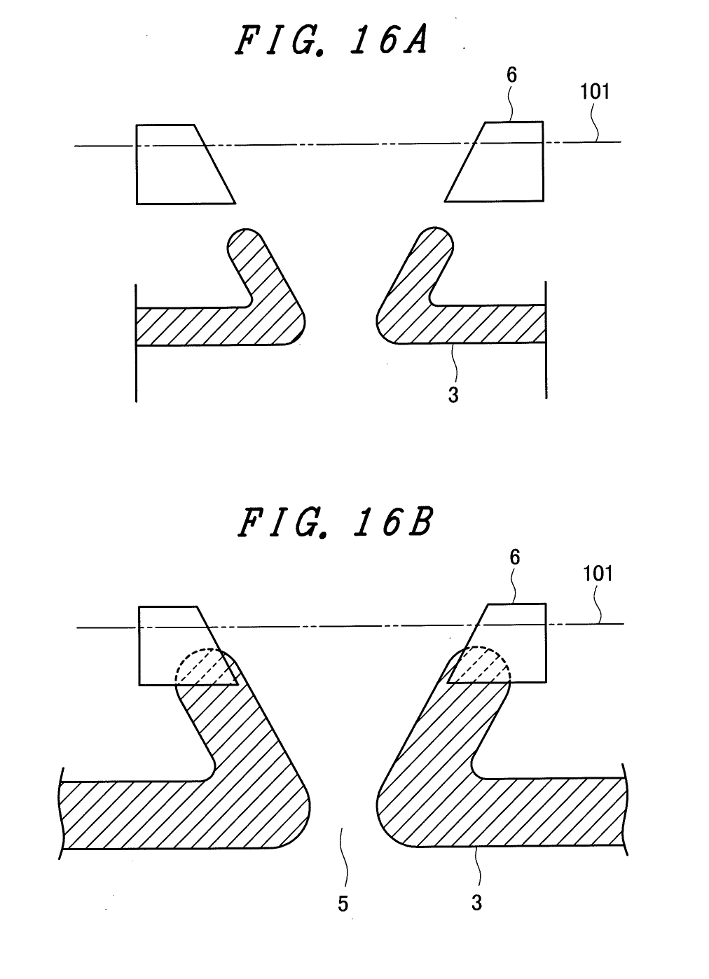

FIG. 16A and FIG. 16B show other examples of the shape of the sealing-inlet columnar spacer 6. As shown in FIG. 16A, the plan view of the sealing-inlet columnar spacer 6 in this case is a simple trapezoid. Even if the sealing-inlet columnar spacer 6 is formed in a simple shape as shown in FIG. 16A, the sealing-inlet columnar spacer 6 can serve as a stopper against the edge sealing material 3 as shown in FIG. 16B. Also in this case, it is preferable that the inside of the sealing inlet of the sealing-inlet columnar spacer 6 is configured so as to spread toward the outside of the substrate in order to improve a reliability of the sealing inlet portion of the sealing-inlet columnar spacer 6. When boding the TFT mother substrate 100 and the opposite mother substrate 200 together, if the edge sealing material 3 crushes and spreads, apart of the edge sealing material 3 enters between the sealing-inlet columnar spacer 6 and the TFT substrate 1 by the capillary phenomenon as same as explained in FIG. 5.

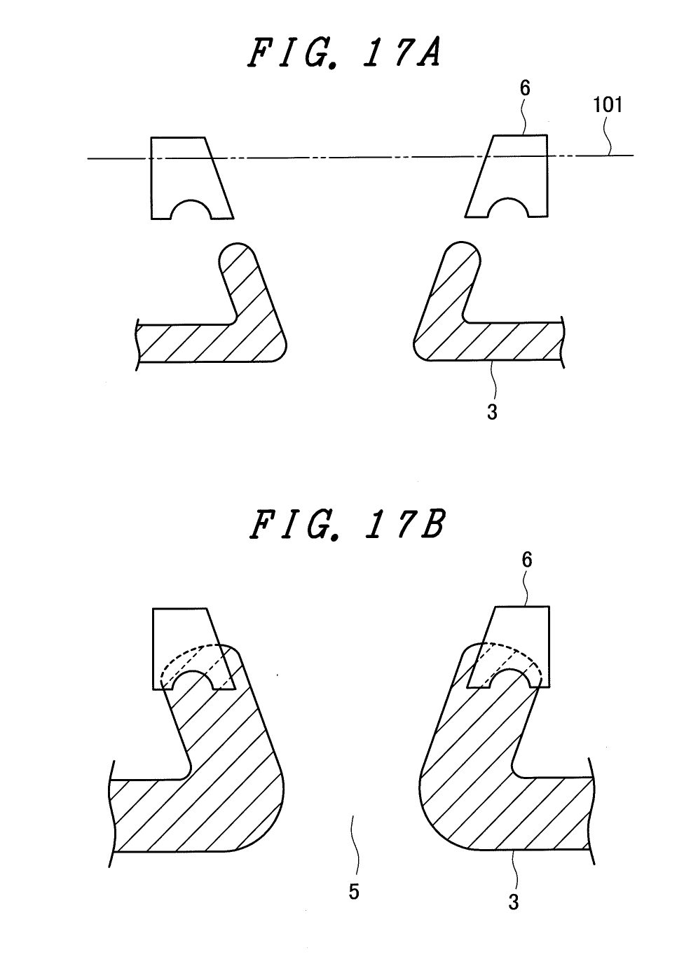

FIG. 17A and FIG. 17B show still other example of the shape of the sealing-inlet columnar spacer 6. As shown in FIG. 17A, the sealing-inlet columnar spacer 6 in this case has an arc notch on the bottom of the trapezoid. Due to this notched portion, it is possible to prevent the edge sealing material 3 from running over to the adjacent liquid crystal cells 10 more effectively. Also in this case, the inside of the sealing inlet of the sealing-inlet columnar spacer 6 is configured to spread toward the outside of the substrate in order to improve a reliability of the end sealing portion after the end sealing material 7 is applied as same as other examples. When boding the TFT mother substrate 100 and the opposite mother substrate 200 together, if the edge sealing material 3 crushes and spreads, a part of the edge sealing material 3 enters between the sealing-inlet columnar spacer 6 and the TFT substrate 1 by the capillary phenomenon as same as FIG. 5 or the like.

### Embodiment 2

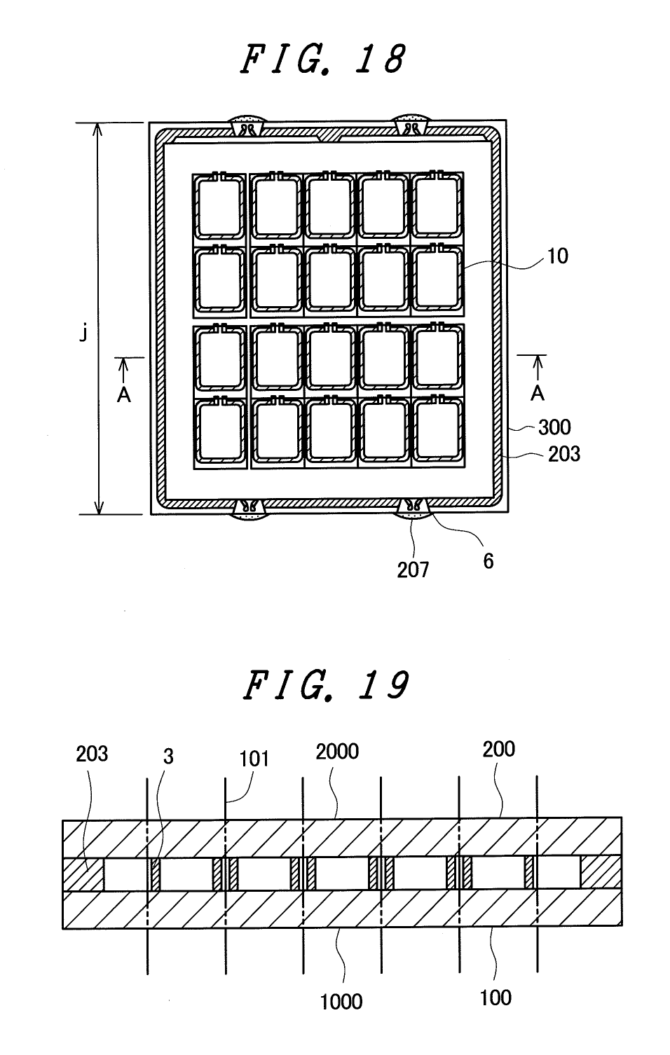

FIG. 18 shows a second embodiment according to the present invention. The liquid crystal cell 10 is required to make the plate thickness of the TFT substrate 1 or the opposite substrate 2 smaller for making the thickness of the entire display device smaller. The TFT substrate 1 or the opposite substrate 2 is made of a glass. The thickness of a glass substrate is standardized and generally, the thickness is about 0.5 mm. If the thickness of the glass substrate is changed, the cost of the glass substrate is increased. In addition, the manufacturing device also adapts to the standardized thickness of the glass substrate, so that it is difficult to manufacture the display device if the glass substrate of thinner plate thickness is used.

However, the side of the display device may demand the TFT substrate 1 or the opposite substrate 2 with the plate thickness of about 0.2 mm. As means for responding to this demand, there is a method to make the glass substrate thinner by polishing after the liquid crystal cell 10 is finished. It is not efficient to polish the TFT substrate 1 or the opposite substrate 2 after cutting off each liquid crystal cell 10. Accordingly, if the outsides of the TFT substrate 1 and the opposite substrate 2 are polished with the TFT mother substrate 100 and the opposite mother substrate 200 being bonded together, it is possible to polish many liquid crystal cells 10 at once.

In the state that the TFT mother substrate 100 and the opposite mother substrate 200 are bonded together, the sealing inlet 5 of the liquid crystal cell 10 has not been sealed yet, so that a polish liquid or the like enters the liquid crystal cell 10 through the sealing inlet 5. Thus, the liquid crystal cell 10 cannot be used as the display device. In order to avoid this, when bonding the TFT mother substrate 100 and the opposite mother substrate 200 together, a mother substrate edge sealing material 203 is formed around the opposite mother substrate 200. Then, a sealing inlet is formed on a part of the mother substrate edge sealing material 203 so as to be sealed by a mother substrate end sealing material 207. Roles of the mother substrate edge sealing material 203 and the mother substrate end sealing material 207 are to prevent the polish liquid or the like from entering the inside of the mother substrate on the contrary to roles of the edge sealing portions and the end sealing portions of the liquid crystal 10.

Conventionally, since the edge sealing material 203 runs over to the outside in the end sealing portion of the mother substrate, two sides of the glass substrate are cut off when sealing the sealing inlet by the end sealing material 207. In other words, the end of the substrate in a j direction shown in FIG. 18 is cut off. According to the present embodiment, as shown in FIG. 18, since the sealing-inlet columnar spacer 6 is formed also in the sealing inlet of the mother substrate, the sealing-inlet columnar spacer 6 serves as a stopper so as to prevent the mother substrate edge sealing material 203 from largely running over from the mother substrate sealing inlet toward the outside. As a result, since a margin of the glass substrate which corresponds to the amount that the edge sealing material 203 moves to the outside can be omitted in advance, it is possible to improve a usage efficiency of the mother substrate.

In FIG. 18, the sealing inlets are formed on two opposite sides of the mother substrate. In FIG. 18, sometimes, the size of the sealing-inlet columnar spacer 6 is different from others, however, the shape thereof is the same as that of the sealing-inlet columnar spacer 6 formed on the liquid crystal cell 10. The sealing-inlet columnar spacer 6 can be manufactured by photo lithography at the same time as the columnar spacer in the display area as same as the sealing-inlet columnar spacer 6 of the liquid crystal cell 10. Accordingly, if an exposure mask is once made, there is no increase in a manufacturing cost. In addition, as same as the conventional case, the end sealing material 207 can be formed in the sealing inlet. As a result, according to the present embodiment, by polishing the mother substrate, it is possible to obtain many liquid crystal cells 10 from one piece of the mother substrate when manufacturing the liquid crystal cell 10 whose entire thickness is small.

FIG. 19 is a cross sectional view taken on a line A-A of FIG. 18. In FIG. 19, the mother substrate edge sealing material 203 is formed so as to be wider than the edge sealing material 3 of each liquid crystal cell 10. Since the application length of the mother substrate edge sealing material 203 is long, the width thereof is wider than that of the edge sealing material 3 of the liquid crystal cell portion. In FIG. 18, at least one of the outside 1000 of the TFT substrate 1 and the outside 2000 of the opposite substrate 2 is a polished face. As described above, when polishing the mother substrate, the mother substrate edge sealing material 203 prevents the polish liquid from entering or the like from the outside. A dashed line in FIG. 19 is a cutting line 101 of each liquid crystal cell 10. By cutting the mother substrate along the cutting line 101 after polishing the mother substrate, each liquid crystal cell 10 is formed.

A so-called longitudinal electric field system of a liquid crystal display device for driving a liquid crystal by applying an electric field mainly between the TFT substrate and the opposite substrate is described as above. However, it is obvious that the present invention is not limited to this and it can be also applied to a so-called IPS system of a liquid crystal display device for driving a liquid crystal by an electric field in a direction in parallel with the TFT substrate.

What is claimed is:

1. A liquid crystal display device, having:
a first substrate,
a second substrate,
a liquid crystal sandwiched between the first substrate and the second substrate, and
a edge sealing material bonding the first substrate and the second substrate together and having a liquid crystal sealing inlet on a first side;
wherein, on the first side on which the liquid crystal sealing inlet is formed, the position of an end of the first substrate and the position of an end of the second substrate coincide with each other, and
the liquid crystal display device has a columnar member that is located at a portion contacting a front end of a edge sealing material which constitutes an inlet portion of the liquid crystal sealing inlet, and is made of a material having a different component composition from that of the edge sealing material.

2. The liquid crystal display device according to claim 1,
wherein the columnar member serves as a spacer for holding an interval between the first substrate and the second substrate.

3. The liquid crystal display device according to claim 1,
wherein the first substrate has a terminal to be connected to a flexible wiring substrate on a second side that is opposed to the first side, and
on the second side, the end of the second substrate sets back from the end of the first substrate.

4. The liquid crystal display device according to claim 3,
wherein the columnar member is formed on the second substrate.

5. The liquid crystal display device according to claim 1,
wherein the liquid crystal sealing inlet increases the width thereof toward the outside of the liquid crystal display device.

6. The liquid crystal display device according to claim 1,
wherein the columnar member is formed by the same material as that of the spacer for setting an interval between the first substrate and the second substrate, which is formed on the part where the liquid crystal is existed.

7. The liquid crystal display device according to claim 1,
wherein the liquid crystal sealing inlet is sealed by a end sealing material, and the end sealing material contacts the edge sealing material.

8. A manufacturing method of a liquid crystal display device sandwiching a liquid crystal between a first substrate and a second substrate that are bonded with each other via a edge sealing material;
wherein a spacer for defining an interval between the first substrate and the second substrate is formed in a display area of the second substrate and a columnar member is formed on the end of the second substrate at the same time;
the edge sealing material is formed on the outside of the display area of the second substrate so that a liquid crystal sealing inlet is provided in the vicinity of the portion where the columnar member is formed; and
when bonding the first substrate and the second substrate together via the edge sealing material, the edge sealing material is allowed to contact the columnar member.

9. The manufacturing method of the liquid crystal display device according to claim 8,
wherein the front end of the edge sealing material configuring the inlet portion of the liquid crystal sealing inlet is allowed to contact the columnar member.

10. The manufacturing method of the liquid crystal display device according to claim 8,
wherein the first substrate has a thin film transistor, and the second substrate has a color filter.

11. The manufacturing method of the liquid crystal display device according to claim 8,
wherein a plurality of first substrates are formed on the first mother substrate and a plurality of second substrates are formed on the second mother substrate, and the first mother substrate is bonded to the second mother substrate so that the first substrate corresponds to the second substrate, and then, each pair of the first substrate and the second substrate is separated, respectively.

12. The manufacturing method of the liquid crystal display device according to claim 11,
wherein the plurality of the first substrates is continuously arranged on the first mother substrate without a gap so that the portions to be separate of the first substrates being adjacent with each other via a side where the liquid crystal sealing inlet is arranged coincide with each other.

13. A mother substrate of a liquid crystal display device having a first mother substrate on which a plurality of first substrates is arranged and a second mother substrate on which a plurality of second substrates is arranged are boned with each other via a edge sealing material;
wherein the edge sealing material is formed so as to have a sealing inlet on the end of the mother substrate of the liquid crystal display device,
the second substrate is mounted in the display area, and
the mother substrate has a spacer for defining an interval between the first substrate and the second substrate and a columnar member that is located on the position to contact the edge sealing material configuring the inlet of the sealing inlet and formed by the same material as that of the spacer.

14. The mother substrate of the liquid crystal display device according to claim 13,
wherein the mother substrate is polished so as to make the thickness of the substrate thinner.
